(19) United States
(12) Patent Application Publication
(10) Pub. No.: US 2012/0138294 A1
(43) Pub. Date: Jun. 7, 2012

(54) INTERPOLYMER CROSSLINKED GEL AND METHOD OF USING

(76) Inventors: Philip F. Sullivan, Bellaire, TX (US); Rick D. Hutchins, Sugar Land, TX (US); Audrey Mirakyan, Katy, TX (US); Gary John Tustin, Cambridge (GB); Lijun Lin, Sugar Land, TX (US)

(21) Appl. No.: 13/301,240

(22) Filed: Nov. 21, 2011

Related U.S. Application Data
(60) Provisional application No. 61/418,211, filed on Nov. 30, 2010.

(51) Int. Cl. E21B 43/00; C09K 8/588

(52) U.S. Cl. 166/279; 507/225

(57) ABSTRACT

Disclosed herein is a gel or a gel concentrate comprising, polyacrylamide crosslinked with a non-metallic crosslinker comprising a polylactam. A well treatment fluid comprising the gel or the gel concentrate, a method of making the gel or the gel concentrate, and a method of using the gel or the gel concentrate are also disclosed.

### CROSS REFERENCE TO RELATED APPLICATIONS

This application claims priority to and the benefit of provisional application U.S. 61/418,211, filed Nov. 30, 2010, which is hereby incorporated herein by reference in its entirety.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A CD

Not applicable.

### BACKGROUND

The statements in this section merely provide background information related to the present disclosure and may not constitute prior art.

Various methods have been used in the past to achieve gelling including systems triggered by pH adjustment, temperature and the like. Attempts at using gels to address fluid loss in highly porous underground formations include injecting an acidic solution following a polymer solution to produce gelation. However, gelation typically occurs so rapidly that a sufficient indepth plugging is not effectively obtained in the most permeable strata where desired. Other attempts include injecting water, a polymer and a crosslinking agent capable of gelling the polymer. Crosslinking agents are typically sequestered polyvalent metal cations, which are admixed, and, just before injection into an underground formation, an acid is added thereto to effect gelation. However, when the acid is pre-mixed with the gelable composition, the gelation can be too fast, making it necessary to shear the gelled polymer in order to be able to obtain adequate injection, which reduces effectiveness of the gel.

Indepth gelling has also been effected by the controlled gelation of sodium silicate. Also, polymers have previously been gelled in permeable zones by borate ions supplied in various ways. However, forming a gel having adequate control over gelation, gel strength, and gel composition down hole remains an illusive goal.

### BRIEF DESCRIPTION OF THE SEVERAL VIEWS OF THE DRAWINGS

FIG. 1 is a graphical representation showing the effect of dilution on Moduli G′ and G″ of gels according to embodiments of the instant disclosure;

FIG. 2 is a graphical representation showing the effect of temperature on the Grace viscosity of gels according to embodiments of the instant disclosure;

FIG. 3 is a graphical representation showing different polyacrylamides crosslinked with PVP at 6%;

FIG. 4 is a graphical representation showing the effect of the crosslinker concentration on the gel strength of gels according to embodiments of the instant disclosure;

FIG. 5 is a graphical representation showing the effects of PVP molecular weight on gel strength according to embodiments of the instant disclosure;

FIG. 6 is a graphical representation showing gels according to embodiments of the instant disclosure having a low Mw PHPA ˜0.5 million Mw with a 5% hydrolysis; and

FIG. 7 is a graphical representation showing non-ionic polyacrylamide (PAM) (i.e., with 0% hydrolysis) gels with PVP according to embodiments of the instant disclosure.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.”

The following definitions are provided in order to aid those skilled in the art in understanding the detailed description.

The term “treatment”, or “treating”, refers to any subterranean operation that uses a fluid in conjunction with a desired function and/or for a desired purpose. The term “treatment”, or “treating”, does not imply any particular action by the fluid.

The term “fracturing” refers to the process and methods of breaking down a geological formation and creating a fracture, i.e. the rock formation around a well bore, by pumping fluid at very high pressures (pressure above the determined closure pressure of the formation), in order to increase production rates from or injection rates into a hydrocarbon reservoir. The fracturing methods otherwise use conventional techniques known in the art.

As used herein, the new numbering scheme for the Periodic Table Groups are used as in Chemical and Engineering News, 63(5), 27 (1985).

As used herein, the term “liquid composition” or “liquid medium” refers to a material which is liquid under the conditions of use. For example, a liquid medium may refer to water, and/or an organic solvent which is above the freezing point and below the boiling point of the material at a particular pressure. A liquid medium may also refer to a supercritical fluid.

As used herein, the term “polymer” or “oligomer” is used interchangeably unless otherwise specified, and both refer to homopolymers, copolymers, interpolymers, terpolymers, and the like. Likewise, a copolymer may refer to a polymer comprising at least two monomers, optionally with other monomers. When a polymer is referred to as comprising a monomer, the monomer is present in the polymer in the polymerized form of the monomer or in the derivative form of the monomer. However, for ease of reference the phrase comprising the (respective) monomer or the like is used as shorthand.

As used herein, the term gel refers to a solid or semi-solid, jelly-like composition that can have properties ranging from soft and weak to hard and tough. The term “gel” refers to a substantially dilute crosslinked system, which exhibits no flow when in the steady-state, which by weight is mostly liquid, yet behaves like solids due to a three-dimensional crosslinked network within the liquid. It is the crosslinks within the fluid that give a gel its structure (hardness) and contribute to stickiness. Accordingly, gels are a dispersion of molecules of a liquid within a solid in which the solid is the continuous phase and the liquid is the discontinuous phase. In an embodiment, a gel is considered to be present when the Elastic Modulus G′ is larger than the Viscous Modulus G″, when measured using an oscillatory shear rheometer (such as a Bohlin CVO 50) at a frequency of 1 Hz and at 20° C. The measurement of these moduli is well known to one of minimal skill in the art, and is described in An Introduction to Rheology, by H. A. Barnes, J. F. Hutton, and K. Walters, Elsevier, Amsterdam (1997), which is fully incorporated by reference herein.

As used herein, the term “dehydrating” as in “dehydrating a gel” refers to removing water or whatever solvent is present in the gel. Dehydrating may be accomplished by the application of heat, reduced pressure, freeze-drying, or any combination thereof.

As used herein, the term “freeze-drying” refers to the process also known in the art as lyophilization, lyophilization or cryodesiccation, which is a dehydration process in which the temperature of a material is lowered (e.g., freezing the material) and then surrounding pressure is reduced to allow the frozen water in the material to sublimate directly from the solid phase to the gas phase.

The term polyacrylamide refers to pure polyacrylamide homopolymer or copolymer with near zero amount of acrylate groups, a partially hydrolyzed polyacrylamide polymer or copolymer with a mixture of acrylate groups and acrylamide groups formed by hydrolysis and copolymers comprising acrylamide, acrylic acid, and/or other monomers. Hydrolysis of acrylamide to acrylic acid proceeds with elevated temperatures and is enhanced by acidic or basic conditions. The reaction product is ammonia, which will increase the pH of acidic or neutral solutions. Except for severe conditions, hydrolysis of polyacrylamide tends to stop near 66%, representing the point where each acrylamide is sandwiched between two acrylate groups and steric hindrance restricts further hydrolysis. Polyacrylic acid is formed from acrylate monomer and is equivalent to 100% hydrolyzed polyacrylamide.

In an embodiment, a gel comprises greater than 1 wt % polyacrylamide crosslinked with a non-metallic crosslinker.

The non-metallic crosslinkers do not include metals, but are instead organic molecules, oligomers, polymers, and/or the like. In an embodiment, the non-metallic crosslinker comprises a polylactam. Accordingly, in an embodiment, a gel comprises greater than 1 wt % polyacrylamide crosslinked with a non-metallic crosslinker, the non-metallic crosslinker comprising a polylactam.

In an embodiment, the non-metallic crosslinker comprises a polylactam. Polylactams include any oligomer or polymer having pendent lactam (cyclic amide) functionality. Polylactams may be homopolymers, copolymers, block-copolymers, grafted polymers, or any combination thereof comprising from 3 to 20 carbon atoms in the lactam functional group pendent to the polymer backbone. Examples include polyalkyl-beta lactams, polyalkyl-gamma lactams, polyalkyl-delta lactams, polyalkyl-epsilon lactams, polyalkylene-beta lactams, polyalkylene-gamma lactams, polyalkylene-delta lactams, polyalkylene-epsilon lactams, and the like. Other examples of polylactams include polyalkylenepyrrolidones, polyalkylenecaprolactams, polymers comprising Vince lactam (2-azabicyclo[2.2.1]hept-5-en-3-one), decyl lactam, undecyl lactam, lauryl lactam, and the like. The alkyl or alkylene substituents in these polymers can include, in an embodiment, any polymerizable substituent having from 2 to about 20 carbon atoms, e.g., vinyl, allyl, piperylenyl, cyclopentadienyl, or the like. In an embodiment, the non-metallic crosslinker is polyvinylpyrrolidone, polyvinylcaprolactam, or a combination thereof. In an embodiment, the non-metallic crosslinker comprises a polylactam, such as polyvinylpyrrolidone, having a weight average molecular weight of greater than or equal to about 10,000 g/mol and less than or equal to about 2 million g/mol. In an embodiment, the non-metallic crosslinker comprises polyvinylpyrrolidone having a weight average molecular weight of greater than or equal to about 50,000 g/mol and less than or equal to about 0.4 million g/mol.

In an embodiment, the gel comprises polyacrylamide crosslinked with a non-metallic crosslinker, gel comprising, greater than 1 wt % polyacrylamide crosslinked with a polylactam.

In an embodiment, the polyacrylamide has a weight average molecular weight of greater than or equal to about 0.5 million g/mol, or the polyacrylamide has a weight average molecular weight from about 1 million to about 20 million g/mol.

In an embodiment, the polyacrylamide is a partially hydrolyzed polyacrylamide having a degree of hydrolysis of from 0 or 0.01% up to less than or equal to about 40%, or from 0 or 0.05% up to less than or equal to about 20%, or from 0 or 0.1% up to less than or equal to about 50%.

In an embodiment, the gel comprises polyacrylamide crosslinked with a non-metallic crosslinker wherein the polyacrylamide is present in the gel at a concentration of greater than or equal to about 1 wt %, or greater than or equal to about 2 wt % and less than or equal to about 10 wt %, based on the total weight of the gel.

In an embodiment, the gel has a pH of less than or equal to about 3 or greater than or equal to about 9, wherein the gel pH is defined as the pH of a 5% combination of the gel in water. In an alternative embodiment, the gel pH is defined as the pH as determined using a moistened pH probe in contact with the gel, e.g., moistened pH indicator paper.

In an embodiment, the gel according to the present disclosure has a complex viscosity of greater than or equal to about 100 Pa·s at less than or equal to about 0.01 Hz.

In an embodiment, the gel has a G′−G″ of greater than or equal to about 0.10, when determined using an oscillatory shear rheometer at a frequency of 1 Hz and at 20° C.

In an embodiment, a method to produce a gel comprises contacting a composition comprising greater than or equal to about 3 wt % polyacrylamide as described herein with a non-metallic crosslinker as described herein comprising a polylactam at a pH of greater than or equal to about 9, or less than or equal to about 3, at a temperature and for a period of time sufficient to produce the gel, wherein the polyacrylamide concentration in the gel is greater than about 1 wt %, and wherein the amount of the non-metallic crosslinker contacted with the polyacrylamide is sufficient to produce a gel having a concentration of the non-metallic crosslinker in the gel of greater than or equal to about 1 wt %, based on the total weight of the gel.

In an embodiment, the composition comprising greater than or equal to about 3 wt % polyacrylamide is a solution, dispersion, emulsion, or slurry, or an aqueous solution, an aqueous emulsion, an aqueous dispersion or an aqueous slurry. In an embodiment, the non-metallic crosslinker is a solid or a solution, an emulsion, a dispersion, or a slurry, or an aqueous solution, an aqueous dispersion, an aqueous emulsion, or an aqueous slurry when contacted with the polyacrylamide composition.

In an embodiment, a composition comprising greater than or equal to about 3 wt % polyacrylamide is contacted with the non-metallic crosslinker while mixing, stirring, under shear, while being agitated, and/or the like to produce the gel. In an embodiment, the composition comprising greater than or equal to about 3 wt % polyacrylamide is contacted with the non-metallic crosslinker at a temperature of greater than or equal to about 20° C., for a period of time of about 1 minute to about 30 days. In an embodiment, the composition comprising greater than or equal to about 3 wt % polyacrylamide is contacted with the non-metallic crosslinker at a temperature of greater than or equal to about 30° C., greater than or equal to about 40° C., greater than or equal to about 50° C., greater than or equal to about 60° C., for a period of time of about 1 minute to about 10 days, about 5 minutes to about 24 hours, or any combination thereof.

In an embodiment, the amount of polyacrylamide present in the aqueous composition is sufficient to produce a gel having a polyacrylamide concentration of greater than or equal to about 2 wt % and less than or equal to about 10 wt %, based on the total weight of the gel. In an embodiment, the amount of the non-metallic crosslinker contacted with the polyacrylamide is sufficient to produce a gel having a concentration of the non-metallic crosslinker in the gel of greater than or equal to about 2 wt % and less than or equal to about 10 wt %, based on the total weight of the gel.

In an embodiment, a method to produce a gel concentrate comprises contacting an aqueous composition comprising greater than or equal to about 3 wt % polyacrylamide with a non-metallic crosslinker comprising a polylactam at a pH of greater than or equal to about 9, at a temperature and for a period of time sufficient to produce a gel, wherein the polyacrylamide has a weight average molecular weight of greater than or equal to about 0.5 million g/mol, wherein the polyacrylamide concentration in the gel is greater than or equal to about 1 wt %, and wherein the concentration of the non-metallic crosslinker in the gel is greater than or equal to about 1 wt %, based on the total weight of the gel; and dehydrating the gel to produce the gel concentrate.

In an embodiment, dehydrating the gel comprises heating, freeze drying, or otherwise dehydrating the gel to produce the gel concentrate. In an embodiment, the particle size of the gel concentrate may be reduced to facilitate subsequent rehydration and thus reconstitution of the gel concentration to produce the reconstituted gel.

In an embodiment, a method to produce a reconstituted gel comprises contacting an aqueous composition comprising greater than or equal to about 3 wt % polyacrylamide with a non-metallic crosslinker comprising a polylactam at a first pH of greater than or equal to about 9, at a first temperature and for a first period of time sufficient to produce a first gel, wherein the polyacrylamide has a weight average molecular weight of greater than or equal to about 0.5 million g/mol, wherein the polyacrylamide concentration in the first gel is greater than or equal to about 1 wt %, and wherein the concentration of the non-metallic crosslinker in the first gel is greater than or equal to about 1 wt %, based on the total weight of the first gel; dehydrating the first gel to produce a gel concentrate; and contacting the gel concentrate with an aqueous solution at a second pH, at a second temperature and for a second period of time sufficient to produce the reconstituted gel. In an embodiment, the gel concentrate is reconstituted at a second pH of greater than or equal to about 8, or less than or equal to about 5.

In an embodiment, the gel produced according to the instant disclosure absorbs water when placed in contact with an aqueous solution. In an embodiment, the gel in contact with water uptakes greater than or equal to about 100% by weight of water, or greater than or equal to about 200% by weight of water, based on the weight of the gel present.

In an embodiment, the gel is formed at a pH of greater than or equal to about 9 and remains as a gel when the pH of the gel is lowered below 9, or when the pH of the gel is lowered below about 7, below about 5, and/or below about 3. Accordingly, in an embodiment, the gels according to the instant disclosure are non-reversible once formed, pH stable once formed, or a combination thereof.

In an embodiment, the gel is formed at a concentration of polyacrylamide suitable to produce a gel having a polyacrylamide concentration which is greater than or equal to about 1 wt %, based on the total weight of the gel, and then the gel is diluted with a solvent, e.g., an aqueous solvent, and the diluted gel retains a G′ which is higher than a G″ indicating a gel is present. Accordingly, in an embodiment, the gels according to the instant disclosure are non-reversible once formed and are stable upon dilution from 1 wt % dilution up to, and in excess of 1000 wt % dilution, based on the total amount of gel present. Accordingly, a 1:1 dilution of the gel up to a 10:1 dilution and above of the gel to produce a diluted composition, results in a diluted composition comprising the gel.

In an embodiment, the gels are formed and/or reconstituted at a temperature greater than or equal to about 20° C., or greater than or equal to about 30° C., or greater than or equal to about 40° C., or greater than or equal to about 50° C. In an embodiment, the gels retain essentially all of the same physical properties (i.e., are stable) at a temperature of greater than or equal to about 20° C., and less than or equal to about 150° C., or less than or equal to about 120° C., or less than or equal to about 110° C., or less than or equal to about 100° C., or less than or equal to about 90° C.

In an embodiment, a method of treating a wellbore comprises injecting a composition comprising polyacrylamide crosslinked with a non-metallic crosslinker comprising a polylactam into a wellbore. Accordingly, in an embodiment the gel is pre-formed and subsequently injected into the wellbore.

In an embodiment, a method of treating a wellbore comprises injecting a composition comprising greater than or equal to about 3 wt % polyacrylamide into a wellbore; injecting a composition comprising a non-metallic crosslinker comprising a polylactam into the wellbore, and injecting a pH adjusting fluid into the wellbore in an amount sufficient (or calculated to be sufficient) to produce a downhole solution pH of greater than or equal to about 9 or less than or equal to about 3, to produce an in-situ gel comprising greater than or equal to about 1 wt % polyacrylamide and greater than or equal to about 1 wt % of the non-metallic crosslinker, based on the amount of the gel. As is obvious to one of skill in the art, it may be impossible to obtain measurements downhole. Accordingly, the amounts sufficient may be determined based on calculations which include assumptions about the downhole conditions. The presence of a gel down hole may be determined by other indicators other than rheological measurements.

In an embodiment, the amount of polyacrylamide present in the polyacrylamide composition injected into the wellbore is sufficient to produce a gel having a polyacrylamide concentration of greater than or equal to about 2 wt % and less than or equal to about 10 wt %, based on the total weight of the gel. In an embodiment, the amount of the non-metallic crosslinker injected into the wellbore is sufficient to produce a gel having a concentration of the non-metallic crosslinker in the gel of greater than or equal to about 2 wt % and less than or equal to about 10 wt %, based on the total weight of the gel.

In and embodiment, the composition comprising greater than or equal to about 3 wt % polyacrylamide, the composition comprising the non-metallic crosslinker, and the pH adjustment fluid are injected into the wellbore separately, simultaneously, or any combination thereof. Accordingly, in an embodiment, the composition comprising the polyacrylamide and the composition comprising the non-metallic crosslinker may be combined and then injected into the well bore either prior to or after the injection of the pH adjustment fluid into the wellbore. In an embodiment, the composition comprising the polyacrylamide and the pH adjustment fluid may be combined and then injected into the well bore either prior to or after the injection of the composition comprising the non-metallic crosslinker into the wellbore. In an embodiment, the composition comprising the non-metallic crosslinker and the pH adjustment fluid may be combined and then injected into the well bore either prior to or after the injection of the composition comprising the polyacrylamide into the wellbore.

In an embodiment, the pH adjusting fluid is an aqueous solution comprising a base, an acid, a pH buffer, or any combination thereof. In an embodiment, the pH adjusting fluid comprises sodium hydroxide, sodium carbonate, sulfuric acid, hydrochloric acid, an organic acid, carbon dioxide or any combination thereof.

In an embodiment, a method of treating a wellbore comprises injecting a composition comprising a gel concentrate into a wellbore, the gel concentrate comprising polyacrylamide crosslinked with a non-metallic crosslinker comprising a polylactam, wherein the polyacrylamide has a weight average molecular weight of greater than or equal to about 0.5 million g/mol, to produce a reconstituted gel in-situ, the reconstituted gel comprising greater than or equal to about 1 wt % polyacrylamide and greater than or equal to about 1 wt % of the non-metallic crosslinker, based on the amount of the gel calculated to be present. In an embodiment, the gel concentrate is the gel disclosed herein which has been freeze dried or otherwise dehydrated or had at least a portion of the solvent removed to produce the gel concentrate.

In an embodiment, a wellbore treatment fluid comprises a gel comprising, greater than 1 wt % polyacrylamide crosslinked with a non-metallic crosslinker, the non-metallic crosslinker comprising a polylactam.

In an embodiment, a wellbore treatment fluid comprises a first composition comprising greater than or equal to about 3 wt % polyacrylamide; and a second composition comprising a non-metallic crosslinker comprising a polylactam.

In an embodiment, a wellbore treatment fluid comprises a gel concentrate comprising polyacrylamide crosslinked with a non-metallic crosslinker comprising a polylactam.

In an embodiment, the compositions and/or the gels may comprise water, i.e., an aqueous gel, and/or an organic solvent. The organic solvent may be selected from the group consisting of diesel oil, kerosene, paraffinic oil, crude oil, LPG, toluene, xylene, ether, ester, mineral oil, biodiesel, vegetable oil, animal oil, and mixtures thereof. Specific examples of suitable organic solvent include acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diglyme (diethylene glycol dimethyl ether), 1,2-dimethoxy-ethane (glyme, DME), dimethylether, dibutylether, dimethyl-formamide (DMF), dimethyl sulfoxide (DMSO), dioxane, ethanol, ethyl acetate, ethylene glycol, glycerin, heptanes, Hexamethylphosphoramide (HMPA), Hexamethylphosphorous triamide (HMPT), hexane, methanol, methyl t-butyl ether (MTBE), methylene chloride, N-methyl-2-pyrrolidinone (NMP), nitromethane, pentane, Petroleum ether (ligroine), 1-propanol, 2-propanol, pyridine, tetrahydrofuran (THF), toluene, triethyl amine, o-xylene, m-xylene, p-xylene, combinations thereof, and/or the like.

Further solvents include aromatic petroleum cuts, terpenes, mono-, di- and tri-glycerides of saturated or unsaturated fatty acids including natural and synthetic triglycerides, aliphatic esters such as methyl esters of a mixture of acetic, succinic and glutaric acids, aliphatic ethers of glycols such as ethylene glycol monobutyl ether, minerals oils such as vaseline oil, chlorinated solvents like 1,1,1-trichloroethane, perchloroethylene and methylene chloride, deodorized kerosene, solvent naphtha, paraffins (including linear paraffins), isoparaffins, olefins (especially linear olefins) and aliphatic or aromatic hydrocarbons (such as toluene). Terpenes are suitable, including d-limonene, 1-limonene, dipentene (also known as 1-methyl-4-(1-methylethenyl)-cyclohexene), myrcene, alpha-pinene, linalool and mixtures thereof.

Further exemplary organic liquids include long chain alcohols (monoalcohols and glycols), esters, ketones (including diketones and polyketones), nitrites, amides, amines, cyclic ethers, linear and branched ethers, glycol ethers (such as ethylene glycol monobutyl ether), polyglycol ethers, pyrrolidones like N-(alkyl or cycloalkyl)-2-pyrrolidones, N-alkyl piperidones, N,N-dialkyl alkanolamides, N,N,N′,N′-tetra alkyl ureas, dialkylsulfoxides, pyridines, hexaalkylphosphoric triamides, 1,3-dimethyl-2-imidazolidinone, nitroalkanes, nitro-compounds of aromatic hydrocarbons, sulfolanes, butyrolactones, and alkylene or alkyl carbonates. These include polyalkylene glycols, polyalkylene glycol ethers like mono (alkyl or aryl)ethers of glycols, mono (alkyl or aryl)ethers of polyalkylene glycols and poly(alkyl and/or aryl)ethers of polyalkylene glycols, monoalkanoate esters of glycols, monoalkanoate esters of polyalkylene glycols, polyalkylene glycol esters like poly(alkyl and/or aryl) esters of polyalkylene glycols, dialkyl ethers of polyalkylene glycols, dialkanoate esters of polyalkylene glycols, N-(alkyl or cycloalkyl)-2-pyrrolidones, pyridine and alkylpyridines, diethylether, dimethoxyethane, methyl formate, ethyl formate, methyl propionate, acetonitrile, benzonitrile, dimethylformamide, N-methylpyrrolidone, ethylene carbonate, dimethyl carbonate, propylene carbonate, diethyl carbonate, ethylmethyl carbonate, and dibutyl carbonate, lactones, nitromethane, and nitrobenzene sulfones. The organic liquid may also be selected from the group consisting of tetrahydrofuran, dioxane, dioxolane, methyltetrahydrofuran, dimethylsulfone, tetramethylene sulfone and thiophen.

In an embodiment, the well treatment fluid, also referred to as the carrier fluid, may include any base fracturing fluid understood in the art. Some non-limiting examples of carrier fluids include hydratable gels (e.g. guars, poly-saccharides, xanthan, hydroxy-ethyl-cellulose, etc.), a crosslinked hydratable gel, a viscosified acid (e.g. gel-based), an emulsified acid (e.g. oil outer phase), an energized fluid (e.g. an N2 or CO2 based foam), and an oil-based fluid including a gelled, foamed, or otherwise viscosified oil. Additionally, the carrier fluid may be a brine, and/or may include a brine.

In an embodiment, the well treatment fluid may include a viscosifying agent, which may include a viscoelastic surfactant (VES). The VES may be selected from the group consisting of cationic, anionic, zwitterionic, amphoteric, nonionic and combinations thereof. Some non-limiting examples are those cited in U.S. Pat. Nos. 6,435,277 (Qu et al.) and 6,703,352 (Dahayanake et al.), each of which are incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂. In some embodiments, a zwitterionic surfactant of the family of betaine is used.

Exemplary cationic viscoelastic surfactants include the amine salts and quaternary amine salts disclosed in U.S. Pat. Nos. 5,979,557, and 6,435,277 which are hereby incorporated by reference. Examples of suitable cationic viscoelastic surfactants include cationic surfactants having the structure:

R¹N⁺(R²)(R³)(R⁴)X⁻

in which R¹ has from about 14 to about 26 carbon atoms and may be branched or straight chained, aromatic, saturated or unsaturated, and may contain a carbonyl, an amide, a retroamide, an imide, a urea, or an amine; R², R³, and R⁴ are each independently hydrogen or a C₁ to about C₆ aliphatic group which may be the same or different, branched or straight chained, saturated or unsaturated and one or more than one of which may be substituted with a group that renders the R², R³, and R⁴ group more hydrophilic; the R², R³, and R⁴ groups may be incorporated into a heterocyclic 5- or 6-member ring structure which includes the nitrogen atom; the R², R³, and R⁴ groups may be the same or different; R¹, R², R³, and/or R⁴ may contain one or more ethylene oxide and/or propylene oxide units; and X— is an anion. Mixtures of such compounds are also suitable. As a further example, R¹ is from about 18 to about 22 carbon atoms and may contain a carbonyl, an amide, or an amine, and R², R³, and R⁴ are the same as one another and contain from 1 to about 3 carbon atoms.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R¹CON(R²)CH₂X

wherein R¹ is a hydrophobic chain having about 12 to about 24 carbon atoms, R² is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group. Examples include hydrophobic chains derived from a carboxylic acid moiety having from 10 to 30 carbon atoms, or from 12 to 22 carbon atoms. In an embodiment, the carboxylic acid moieties are derived from carboxylic acids selected from the group consisting of capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, resinolic acid, and a combination thereof.

In an embodiment, the carrier fluid includes an acid, a chelant, or both. The fracture may be a traditional hydraulic bi-wing fracture, but in certain embodiments may be an etched fracture and/or wormholes such as developed by an acid treatment. The carrier fluid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In certain embodiments, the carrier fluid includes a poly-amino-poly-carboxylic acid, trisodium hydroxyl-ethyl-ethylene-diamine triacetate, mono-ammonium salts of hydroxyl-ethyl-ethylene-diamine triacetate, and/or mono-sodium salts of hydroxyl-ethyl-ethylene-diamine tetra-acetate. The selection of any acid as a carrier fluid depends upon the purpose of the acid—for example formation etching, damage cleanup, removal of acid-reactive particles, etc., and further upon compatibility with the formation, compatibility with fluids in the formation, and compatibility with other components of the fracturing slurry and with spacer fluids or other fluids that may be present in the wellbore. The selection of an acid for the carrier fluid is understood in the art based upon the characteristics of particular embodiments and the disclosures herein.

The composition may include a particulate blend made of proppant. Proppant selection involves many compromises imposed by economical and practical considerations. Criteria for selecting the proppant type, size, size distribution in multimodal proppant selection, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated (curable), or pre-cured resin coated. Proppants and gravels in the same or different wells or treatments can be the same material and/or the same size as one another and the term proppant is intended to include gravel in this disclosure. In some embodiments, irregular shaped particles may be used such as unconventional proppant. In general the proppant used will have an average particle size of from about 0.15 mm to about 4.76 mm (about 100 to about 4 U.S. mesh), or from about 0.15 mm to about 3.36 mm (about 100 to about 6 U.S. mesh), more or from about 0.15 mm to about 4.76 mm (about 100 to about 4 U.S. mesh), more particularly, but not limited to 0.25 to 0.42 mm (40/60 mesh), 0.42 to 0.84 mm (20/40 mesh), 0.84 to 1.19 mm (16/20), 0.84 to 1.68 mm (12/20 mesh) and 0.84 to 2.38 mm (8/20 mesh) sized materials. Normally the proppant will be present in the slurry in a concentration from about 0.12 to about 0.96 kg/L, or from about 0.12 to about 0.72 kg/L, or from about 0.12 to about 0.54 kg/L. Some slurries are used where the proppant is at a concentration up to 16 PPA (1.92 kg/L). If the slurry is foamed the proppant is at a concentration up to 20 PPA (2.4 kg/L). The slurry composition is not a cement slurry composition.

The composition may comprise particulate materials with defined particles size distribution. Examples of high solid content treatment fluid (HSCF) in which the degradeable latex may be employed are disclosed in U.S. Pat. No. 7,789,146; U.S. Pat. No. 7,784,541; US 2010/0155371; US 2010/0155372; US 2010/0243250; and US 2010/0300688; all of which are hereby incorporated herein by reference in their entireties.

The composition may further comprise a degradable material. In certain embodiments, the degradable material includes at least one of a lactide, a glycolide, an aliphatic polyester, a poly(lactide), a poly(glycolide), a poly(ε-caprolactone), a poly (orthoester), a poly(hydroxybutyrate), an aliphatic polycarbonate, a poly(phosphazene), and a poly(anhydride). In certain embodiments, the degradable material includes at least one of a poly(saccharide), dextran, cellulose, chitin, chitosan, a protein, a poly(amino acid), a poly(ethylene oxide), and a copolymer including poly(lactic acid) and poly (glycolic acid). In certain embodiments, the degradable material includes a copolymer including a first moiety which includes at least one functional group from a hydroxyl group, a carboxylic acid group, and a hydrocarboxylic acid group, the copolymer further including a second moiety comprising at least one of glycolic acid and lactic acid.

In some embodiments, the composition may optionally further comprise additional additives, including, but not limited to, acids, fluid loss control additives, gas, corrosion inhibitors, scale inhibitors, catalysts, clay control agents, biocides, friction reducers, combinations thereof and the like. For example, in some embodiments, it may be desired to foam the storable composition using a gas, such as air, nitrogen, or carbon dioxide.

The composition may be used for carrying out a variety of subterranean treatments, including, but not limited to, drilling operations, fracturing treatments, and completion operations (e.g., gravel packing). In some embodiments, the composition may be used in treating a portion of a subterranean formation. In certain embodiments, the composition may be introduced into a well bore that penetrates the subterranean formation as a treatment fluid. For example, the treatment fluid may be allowed to contact the subterranean formation for a period of time. In some embodiments, the treatment fluid may be allowed to contact hydrocarbons, formations fluids, and/or subsequently injected treatment fluids. After a chosen time, the treatment fluid may be recovered through the well bore. In certain embodiments, the treatment fluids may be used in fracturing treatments.

The method is also suitable for gravel packing, or for fracturing and gravel packing in one operation (called, for example frac and pack, frac-n-pack, frac-pack, STIMPAC (Trade Mark from Schlumberger) treatments, or other names), which are also used extensively to stimulate the production of hydrocarbons, water and other fluids from subterranean formations. These operations involve pumping the composition and propping agent/material in hydraulic fracturing or gravel (materials are generally as the proppants used in hydraulic fracturing) in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the reservoir and the wellbore and also to increase the surface area available for fluids to flow into the wellbore.

### Embodiments

Accordingly, the present disclosure provides the following embodiments:
A. A gel comprising, greater than 1 wt % polyacrylamide crosslinked with a non-metallic crosslinker, the non-metallic crosslinker comprising a polylactam.
B. The gel according to Embodiment A, wherein the polyacrylamide has a degree of hydrolysis less than or equal to about 40%.
C. The gel according to Embodiment A or B, wherein the non-metallic crosslinker comprises greater than or equal to about 1 wt % polyvinylpyrrolidone, polyvinylcaprolactam, or a combination thereof independently having a weight average molecular weight of greater than or equal to about 10,000 g/mol and less than or equal to about 2 million g/mol
D. The gel according to Embodiment A, B, or C, having a pH of less than or equal to about 3 or greater than or equal to about 9.
E. The gel according to Embodiment A, B, C, or D, having a complex viscosity of greater than or equal to about 100 Pa·s at less than or equal to about 0.01 Hz.
F. The gel according to Embodiment A, B, C, D, or E, wherein G′−G″ is greater than or equal to about 0.1 Pa·s when determined using an oscillatory shear rheometer at a frequency of 1 Hz and at 20° C.
G. A method to produce a gel comprising:
contacting a composition comprising greater than or equal to about 3 wt % polyacrylamide with a non-metallic crosslinker comprising a polylactam at a pH of greater than or equal to about 9, or less than or equal to about 3, at a temperature and for a period of time sufficient to produce the gel,

wherein the polyacrylamide concentration in the gel is greater than about 1 wt % based on the total weight of the gel.
H. The method according to Embodiment G, wherein the amount of the non-metallic crosslinker contacted with the polyacrylamide is sufficient to produce a gel having a concentration of the non-metallic crosslinker in the gel of greater than or equal to about 1 wt %, based on the total weight of the gel.
I. The method according to Embodiment G or H, wherein the non-metallic crosslinker comprises polyvinylpyrrolidone, polyvinylcaprolactam, or a combination thereof independently having a weight average molecular weight of greater than or equal to about 10,000 g/mol and less than or equal to about 2 million g/mol.
J. The method according to Embodiment G, H, or I, wherein the temperature is greater than or equal to about 50° C.
K. A method to produce a gel concentrate comprising:
contacting a composition comprising greater than or equal to about 3 wt % polyacrylamide with a non-metallic crosslinker comprising a polylactam at a pH of greater than or equal to about 9, at a temperature and for a period of time sufficient to produce a gel,
   wherein the polyacrylamide concentration in the gel is greater than about 1 wt %, and dehydrating the gel to produce the gel concentrate.
   L. The method according to Embodiment K, wherein the dehydrating the gel comprises freeze drying.
   M. The method according to Embodiment K or M, wherein the non-metallic crosslinker comprises polyvinylpyrrolidone, polyvinylcaprolactam, or a combination thereof independently having a weight average molecular weight of greater than or equal to about 10,000 g/mol and less than or equal to about 2 million g/mol, and

wherein the concentration of the non-metallic crosslinker in the gel is greater than or equal to about 1 wt %, based on the total weight of the gel.
N. A method to produce a reconstituted gel comprising:
contacting a composition comprising greater than or equal to about 3 wt % polyacrylamide with a non-metallic crosslinker comprising a polylactam at a first pH of greater than or equal to about 9, at a first temperature and for a first period of time sufficient to produce a first gel,
   wherein the polyacrylamide concentration in the first gel is greater than about 1 wt %, dehydrating the first gel to produce a gel concentrate; and
   contacting the gel concentrate with an aqueous solution at a second pH, at a second temperature and for a second period of time sufficient to produce the reconstituted gel.
   O. The method according to Embodiment N, wherein the non-metallic crosslinker comprises polyvinylpyrrolidone, polyvinylcaprolactam, or a combination thereof independently having a weight average molecular weight of greater than or equal to about 10,000 g/mol and less than or equal to about 2 million g/mol, and

wherein the concentration of the non-metallic crosslinker in the first gel is greater than or equal to about 1 wt %, based on the total weight of the first gel.
P. A method of treating a wellbore comprising:

injecting a composition comprising a gel into a wellbore, wherein the gel comprises greater than 1 wt % polyacrylamide crosslinked with a non-metallic crosslinker comprising a polylactam, based on the total amount of the gel present.
Q. A method of treating a wellbore comprising:

injecting a composition comprising greater than or equal to about 3 wt % polyacrylamide into a wellbore;

injecting a composition comprising a non-metallic crosslinker comprising a polylactam into the wellbore, and

injecting a pH adjusting fluid into the wellbore in an amount sufficient to produce a downhole solution pH of greater than or equal to about 9 or less than or equal to about 3, to produce an in-situ gel comprising greater than about 1 wt % polyacrylamide crosslinked with the non-metallic crosslinker,

wherein the composition comprising greater than or equal to about 3 wt % polyacrylamide, the composition comprising a non-metallic crosslinker, and the pH adjustment fluid are injected into the wellbore separately, simultaneously, or any combination thereof.
R. The method according to Embodiment Q, wherein the non-metallic crosslinker comprises polyvinylpyrrolidone, polyvinylcaprolactam, or a combination thereof independently having a weight average molecular weight of greater than or equal to about 10,000 g/mol and less than or equal to about 2 million g/mol, and

wherein the amount of non-metallic crosslinker injected is sufficient to produce the in-situ gel having a non-metallic crosslinker concentration of greater than or equal to about 1 wt %, based on the total weight of the in-situ gel.
S. A method of treating a wellbore comprising:

injecting a composition comprising a gel concentrate into a wellbore, the gel concentrate comprising polyacrylamide crosslinked with a non-metallic crosslinker comprising a polylactam to produce an in-situ reconstituted gel comprising greater than about 1 wt % polyacrylamide crosslinked with the non-metallic crosslinker.
T. The method according to Embodiment S, wherein the non-metallic crosslinker comprises polyvinylpyrrolidone, polyvinylcaprolactam, or a combination thereof having a weight average molecular weight of greater than or equal to about 10,000 g/mol and less than or equal to about 2 million g/mol, and

wherein the concentration of the non-metallic crosslinker in the reconstituted gel is greater than or equal to about 1 wt %, based on the total weight of the reconstituted gel.
T. A well treatment fluid comprising a gel comprising, greater than 1 wt % polyacrylamide crosslinked with a non-metallic crosslinker, the non-metallic crosslinker comprising a polylactam.
U. A well treatment fluid comprising a first composition comprising greater than or equal to about 3 wt % polyacrylamide; and

a second composition comprising a non-metallic crosslinker comprising a polylactam.
V. A well treatment fluid comprising a gel concentrate comprising polyacrylamide crosslinked with a non-metallic crosslinker comprising a polylactam.

### Examples

The following examples show that gels according to the instant disclosure may be formed at ambient temperature provided the solution has an alkaline pH, and may be formed at an acidic pH upon heating. In all cases, the formed gels appear to be very elastic and sticky in nature. The gels will absorb and swell when placed in water, uptaking more than 200% of their weight. Unlike the low pH interpolymer complexes discussed in the literature, the clear gels of the instant disclosure are irreversible to changes in pH and have excellent high temperature stability. Gel formation can occur at ambient temperature or elevated temperature as long as the pH is alkaline. It was discovered that the gel is not formed by hydrogen bonding and thus is not a complex as seen at low pH, but is instead the result of a non-reversible chemical reaction between the polyacrylamide and the non-metallic crosslinker. When the non-metallic crosslinker is a polylactam, such as PVP, the crosslinking appears to result from a ring-opening event wherein the lactam ring is opened to produce a bond between an acrylamide or acrylate moiety and the lactam moiety to produce the gel.

Partially hydrolyzed polyacrylamide (PHPA) at 3% and polyvinylpyrrolidone (PVP) at 3-6% forms a very elastic gel when heated. It has also been discovered that heating was not required if the pH was alkaline, but a gel would form under acidic conditions if heated. It is speculated that the heating step generates alkalinity by further hydrolysis of the PHPA generating ammonia ions that raised the pH and initiated the gelation. Scanning Electron Microscopy (SEM) and phase contrast micrographs of dried gels according to the instant disclosure show gels having a linear, fibrous character to them and possibly form hollow vesicles.

A gel formed from 3% PHPA and 6% PVP absorbed sufficient water (200% by weight) to yield a strong gel at a final concentration of 1% PHPA and 2% PVP. However, it was discovered that mixing 1% PHPA and 2% PVP in water under gel forming conditions does not produce a gel. Accordingly, it was discovered that the gels according to the instant disclosure are formed by a unique pathway, which suggests that to produce gels having a final polyacrylamide concentration of 0.5 to 1 wt %, the concentration of the polyacrylamide composition must be initially higher than 1 wt %, typically at least about 2 wt % to at least about 3 wt %, and then subsequently diluted via addition of the non-metallic crosslinker to form the gels having a final polyacrylamide concentration of 0.5 to 1 wt.

Gels were also prepared with different molecular weights, concentrations and hydrolysis level of PHPA, and various molecular weights of PVP were evaluated.

The data further shows the gel may be freeze dried and later reconstituted by hydrating the gel concentrate particles to produce a reconstituted gel. A temperature delayed gelation for water control is possible. Other methods include the use of the instant gel particles as friction reducers, delayed viscosity booster in hydraulic fracturing, diverting agent in stimulation via viscosity and gel formation, temporary plug creation, water absorbing gel for water control, and a low viscosity cleanout fluid that generates viscosity downhole to lift sand and other solids to the surface.

In one set of examples, the method to produce the gels was to mix solutions of polyacrylamide with solutions of the various polylactam polymers under a variety of conditions and then determine if a gel formed. Ambient and elevated temperature conditions and several pH levels from acidic to basic were evaluated. The solutions were observed for days to weeks for gel formation. When a gel formed, the gel was further characterized by visual observation, rheological measurements, and the effects of water dilution or acidic solutions on the formed gel. Low pH gels were characterized by separating the free water that invariably formed from the gel portion and evaluating the gel portion.

### Gel Formation

The mixing procedure to produce the gels was to fully hydrate the PHPA in deionized water using an overhead stirrer running at 600 RPM. Powdered polyacrylamide polymer was gradually added to the shoulder of the vortex over a 20 second period to avoid the formation of clumps or fisheyes. Stirring continued for about an hour or until all of the polymer particles had fully hydrated as seen by visual observation. Next, the non-metallic crosslinker was added and stirring continuously until it had also fully hydrated or dissolved. The pH of the mixture was measured before splitting the sample into several parts. Each part was then adjusted to the various levels of pH using 10% HCl or 10% NaOH solutions. The final pH was measured and recorded, The presence of gels was evaluated by periodic visual observation. As an example, the fluid with 3% PHPA and 6% PVP was prepared as follows:

3 grams of PHPA were added to 97 grams of DI water and stirred until fully hydrated to give a true 3 wt % solution.

6 grams of PVP was then added to the solution and stirred until fully dissolved. This results in a solution that is 2.83 wt % PHPA and 5.66 wt % PVP, although it is referred to as 3% PHPA and 6% PVP.

The native pH of the mixture was then measured and the mixture separated into 4 parts. The pH of each portion of the solution was then adjusted to nominal values of 1, 3, and 9 using 10% HCl or 10% NaOH. The fourth portion was at the native pH.

### Rheological Characterization

Rheology was measured at low temperature (less than 80° C.) using a Bohlin rheometer with 25 mm cup and bob operating under dynamic mode (frequency sweep at 10% strain). The resulting moduli (G′, G″) when determined using an oscillating shear rheometer at 1 Hz at 20° C., and complex viscosity were used to evaluate gel formation. When G′ at least 0.1, or at least 1, or at least 5, or at least 10 Pa·s larger than G″, this suggests the existence of a gel and the magnitude of G′ quantifies the gel strength. When G″ is larger than G′, this suggests a liquid is present and no gel has formed. The complex viscosity should be comparable to the steady state viscosity if the material being tested follows the Cox-Merx rule.

A Grace 5600 model 50 viscometer was used to generate rheological data which was beyond the capabilities of the cup and bob method. Viscosity build of the gels was monitored by adding 50 mL of the solution to the cup, attaching the cup and applying nitrogen pressure of about 400 psi before heating was begun. As temperature rose, the initially viscous fluid would decrease in viscosity (thermal thinning) until a certain point where gelation was initiated and then the viscosity would rise. Gelation extent was monitored by the final attained viscosity.

### Visual Observations

The results of the ambient screening for gel formation are shown in Table 1. For the listed PHPA polymers, the molecular weight and % hydrolysis are shown in parentheses in the first row of the heading and the concentration is noted. The second row of the heading shows the concentration of the non-metallic crosslinker. The nominal pH is shown to the left of the remaining rows of data. For each cell, the observation is recorded. An “N” shows no gelation while a “G” indicates gelation. A phase separated gel consisting of gel and free water is indicated by “P/S”. The actual measured pH of the solution is shown in parentheses. These observations were generally recorded after one week of observation and represent the state at that time. Most of the gels formed over several days, although one cationic polyacrylamide sample gelled immediately.

For purposes herein the wt % of the PHPA is listed followed by the weight average molecular weight, expressed as either million Daltons (MDa) or in grams per mol (g/mol), followed by the % hydrolysis of the PHPA expressed as a wt %. Accordingly, the heading: 2% PHPA, 12.5 MDa, 30% Hyd represents a composition comprising 2 wt % PHPA having a weight average molecular weight of 12.5 million Daltons, and a 30 wt % hydrolysis of acrylamide to acrylate. The weight average molecular weight may also be abbreviated “MW”, which indicates g/mol. Accordingly, 3% PVP, 300 k MW represents a 3 wt % polyvinylpyrrolidone (PVP) composition wherein the PVP has a weight average molecular weight of 300,000 g/mol.

TABLE 1

| | 2% PHPA | 2% PHPA | 2% PHPA | 2% PHPA | 2% PHPA |
|---|---|---|---|---|---|
| | 12.5 MDa | 6 MDa | 12 MDa | 12 MDa | 11 MDa |
| | 30% Hyd | 30% Hyd | 5% Hyd | 12% Hyd | 20% Hyd |
| pH | 3% PVP | 3% PVP | 3% PVP | 3% PVP | 3% PVP |
| | 300k MW | 300k MW | 300k MW | 300k MW | 300k MW |
| 3 | N (3.0) | N (2.6) | N (2.5) | N (2.4) | N (2.4) |
| 5.6 | N (6.7) | N (6.9) | N (5.2) | G (5.9) | N (5.6) |
| 9 | N (9.1) | N (8.9) | N (9.1) | G (9.1) | N (8.9) |
| | 2% PHPA | 2% PHPA | 2% PHPA | 2% PHPA | 2% PHPA |
| | 12.5 MDa | 6 MDa | 12 MDa | 12 MDa | 11 MDa |
| | 30% Hyd | 30% Hyd | 5% Hyd | 12% Hyd | 20% Hyd |
| pH | 6% PVP | 6% PVP | 6% PVP | 6% PVP | 6% PVP |
| | 300k MW | 300k MW | 300k MW | 300k MW | 300k MW |
| 3 | N (3.0) | N (3.0) | P/S (2.7) | P/S (2.4) | N (2.9) |
| 5.6 | N (6.4) | N (6.6) | N (5.1) | G (5.3) | N (6.1) |
| 9 | N (9.2) | N (9.1) | G (9.1) | G (9.1) | N (9.2) |
| | 3% PHPA | 3% PHPA | 3% PHPA | 3% PHPA | 3% PHPA |
| | 12.5 MDa | 6 MDa | 12 MDa | 12 MDa | 11 MDa |
| | 30% Hyd | 30% Hyd | 5% Hyd | 12% Hyd | 20% Hyd |
| pH | 3% PVP | 3% PVP | 3% PVP | 3% PVP | 3% PVP |
| | 300k MW | 300k MW | 300k MW | 300k MW | 300k MW |
| 3 | N (2.5) | P/S (2.8) | G (2.8) | G (2.5) | N (2.7) |
| 5.6 | G (6.7) | G (6.7) | G (5.5) | G (6.1) | G (6.4) |
| 9 | G (9.0) | G (9.0) | G (9.0) | G (9.3) | G (9.1) |
| | 3% PHPA | 3% PHPA | 3% PHPA | 3% PHPA | 3% PHPA |
| | 12.5 MDa | 6 MDa | 12 MDa | 12 MDa | 11 MDa |
| | 30% Hyd | 30% Hyd | 5% Hyd | 12% Hyd | 20% Hyd |
| pH | 6% PVP | 6% PVP | 6% PVP | 6% PVP | 6% PVP |
| | 300k MW | 300k MW | 300k MW | 300k MW | 300k MW |
| 3 | N (2.6) | P/S (2.7) | G (2.5) | G (3.0) | N (2.7) |
| 5.6 | G (6.5) | N (6.5) | G (5.1) | G (5.3) | G (6.1) |
| 9 | G (9.4) | G (9.4) | G (9.4) | G (9.2) | G (9.0) |

As shown in Table 1, the PHPA was evaluated at concentrations of 2% and 3% by weight. This series spanned molecular weights from 6 to 12.5 million Daltons and hydrolysis levels from 5 to 30%. The non-metallic crosslinker included 3 and 6 wt % PVP with a reported molecular weight of 300,000 Daltons.

In general, gels were formed using both 3 and 6% of PVP when 3% of PHPA was used, but not with 2% PHPA. However, PHPA polymers with a molecular weight of 12 million did gel at 2%. At low pH with PVP, the lower hydrolysis PHPA gelled while higher levels (20% or more) either phase separated or did not gel. In all cases with PHPA, phase separation was limited to the low pH regime below 4. In nearly every case a pH of 9 or more resulted in gelation for 3% PHPA at ambient temperature.

Shown in Table 2 are results obtained with PHPA having different molecular weights and levels of hydrolysis than those in Table 1. With PHPA, very similar results to those found in Table 1 are apparent. The low molecular weight PHPA polymers showed no reaction at 5%, suggesting the concentration and molecular weight are relevant factors in gel formation. The cationic PHPA initially gelled immediately, but later phase separated at all pH levels above 3. An observation after 3 weeks reveals that the pH 11.2 sample is clear and gelled. Below pH 3, the sample remained gelled.

TABLE 2

| | 3% PHPA | | 3% PHPA | | 3% PHPA | | 3% PHPA | | 2% PHPA | | 2% PHPA | |
|---|---|---|---|---|---|---|---|---|---|---|---|---|
| | 5 MDa | | 5 MDa | | 5 MDa | | 5 MDa | | 5 MDa | | 5 MDa | |
| | 10% Hyd | | 10% Hyd | | 10% Hyd | | 10% Hyd | | 10% Hyd | | 10% Hyd | |
| pH | 3% PVP | | 4% PVP | | 5% PVP | | 6% PVP | | 4% PVP | | 6% PVP | |
| | 300k MW | | 300k MW | | 300k MW | | 300k MW | | 300k MW | | 300k MW | |
| 1 | N | (1.2) | P/S | (1.1) | P/S | (1.1) | P/S | (1.0) | N | (2.85) | P/S | (1.4) |
| 3 | G | (3.0) | N | (3.2) | P/S | (2.9) | P/S | (3.0) | — | | — | |
| 5.6 | G | (4.9) | N | (5.2) | N | (5.7) | N | (5.6) | N | (5.6) | N | (4.5) |
| 9 | G | (9.1) | N | (9.0) | G | (9.0) | G | (9.2) | N | (9.2) | N | (9.1) |

| | | | | | | | | | 3% PHPA | |
|---|---|---|---|---|---|---|---|---|---|---|
| | 3% PHPA | | 3% PHPA | | 5% PHPA | | 5% PHPA | | 9 MDa | |
| | 5 MDa | | 5 MDa | | 0.5 MDa | | 0.5 MDa | | 30% Hyd | |
| | 10% Hyd | | 10% Hyd | | 5% Hyd | | 1% Hyd | | cationic | |
| pH | 4% PVP | | 6% PVP | | 6% PVP | | 6% PVP | | 6% PVP | |
| | 2.5k MW | | 2.5k MW | | 300k MW | | 300k MW | | 300k MW | |
| 1 | — | | — | | — | | — | | G | (2.6) |
| 3 | N | (3.0) | N | (3.0) | N | (3.0) | N | (2.9) | P/S | (5.0) |
| 5.6 | G | (5.1) | G | (5.1) | N | (5.0) | N | (3.9) | P/S | (9.2) |
| 9 | G | (9.0) | G | (9.0) | N | (9.0) | N | (8.9) | P/S | (11.2) |

| | | | | | | | |
|---|---|---|---|---|---|---|---|
| 11 | G | (11.5) | G | (11.0) | — | — | — |

Table 3 shows results obtained with an unhydrolyzed polymer or pure polyacrylamide. Substantial differences exist from the conclusions drawn about PHPA. Phase separation occurred at high pH and gelation occurred at lower pH levels. The gelation behavior was very sensitive to the concentration of PVP, where 3% gelled and 6% phase separated.

TABLE 3

| | 3% PA | 3% PA |
|---|---|---|
| | 6 MDa | 6 MDa |
| | 0% Hyd | 0% Hyd |
| pH | 3% PVP | 6% PVP |
| | 300k MW | 300k MW |
| 1 | N (1.1) | P/S (1.15) |
| 3 | P/S (3.0) | P/S (3.5) |
| 5.6 | P/S (4.0) | P/S (7.5) |
| 9 | G (9.1) | P/S (8.9) |

### SEM

Scanning electron microscope pictures of the PHPA-PVP dried gel reveal an interesting structure resembling tubes and a fibrous sheath in which the fibers have aligned. Analysis shows holes which appear to be exits of tunnels formed by aligned gel. Alignment of the fibrous network is apparent. The outer wall appears quite smooth.

### Rheology-Bohlin

Dynamic rheology provides further characterization of the gels.

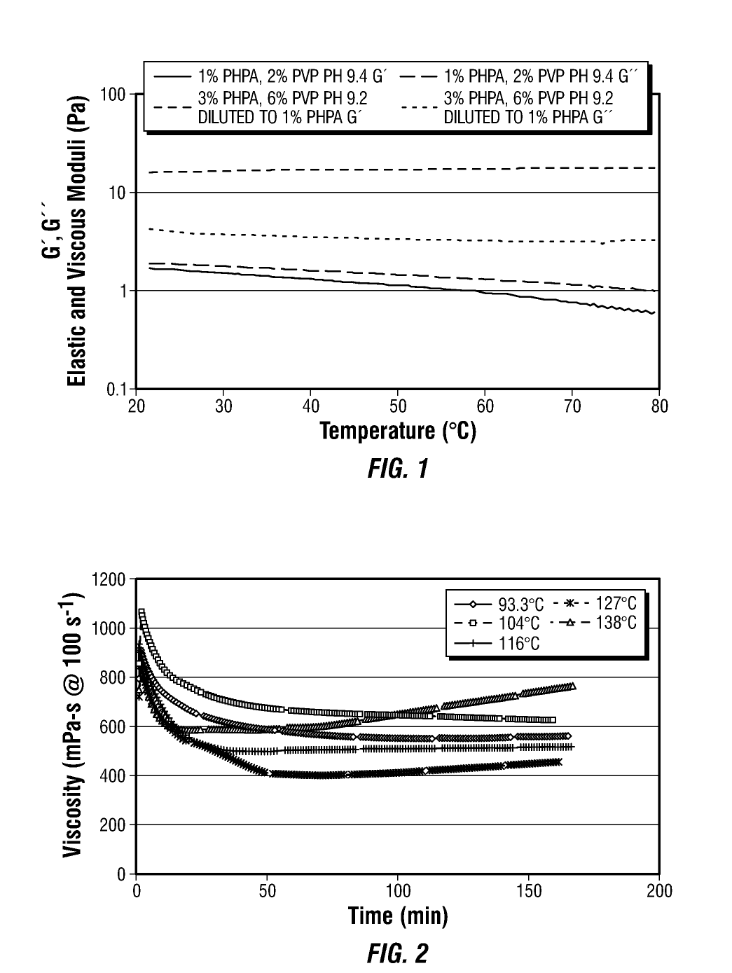

FIG. 1 demonstrates that a gel can be made at 3% PHPA but not at 1%. The 3% gel was diluted with twice its weight of water resulting in the same overall composition of PHPA and PVP as the 1% PHPA sample. The G′ of the diluted gel exceeds the G″ value, indicating a true gel exists, whereas the 1% PHPA mixture suggests a viscous liquid exists since G′ is less than G″. G′ for the diluted sample is much higher than that for the 1% PHPA sample. In addition, the gel moduli are fairly independent of temperature but the liquid shows decreasing moduli with temperature. Thus, the reaction that occurred in the solution with 3% PHPA and 6% PVP appears irreversible upon dilution. This also demonstrates that the gelation mechanism is path dependent.

### Rheology-Grace

The Grace 5600 viscometer was used to observe the onset of gelation with temperature. Temperature accelerates the reaction and can also increase the hydrolysis level of PHPA or polyacrylamide in the presence of base.

The examples in FIG. 2 show a mixture of 3% PHPA and 6% PVP, which was heated in the viscometer. The gel was tested at several temperatures from 200 to 280° F. All tests resulted in similar gels of 600 to 800 cP at temperature. The fluids at 260 and 280° F. show upturns in viscosity that indicate the onset of gelation. After cooling, the fluids were fully gelled.

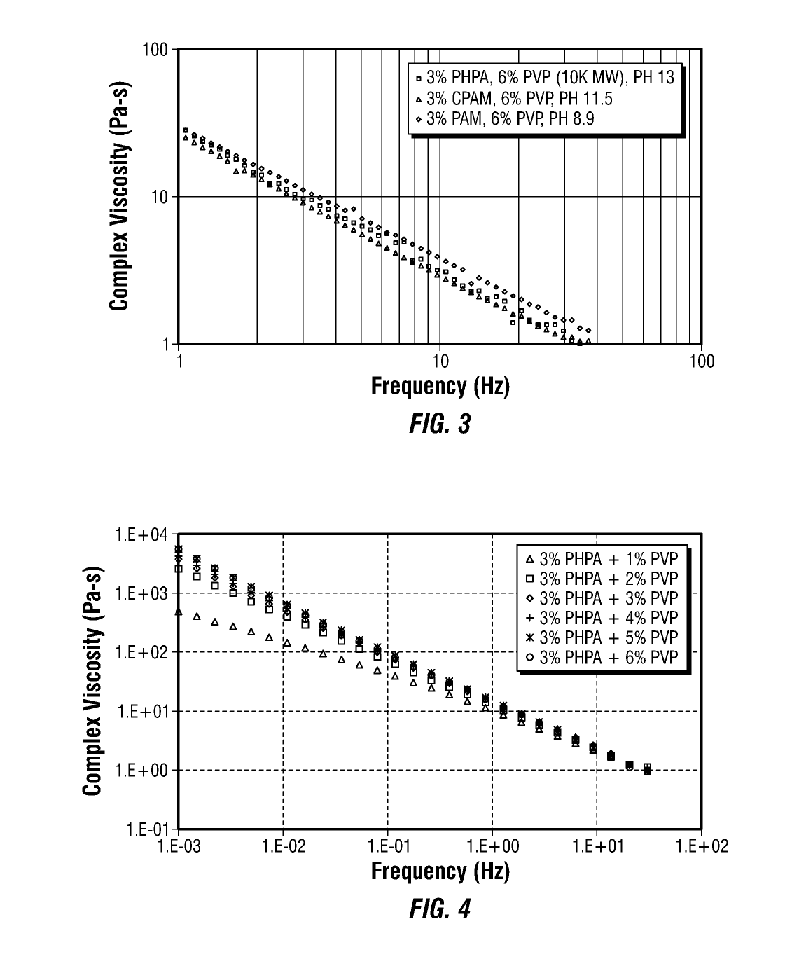

FIG. 3 shows a comparison between different base polymers with PVP at 6%. Similar gels are formed for PHPA, unhydrolyzed polyacrylamide (PAM) and cationic polyacrylamide (CPAM).

A series of samples were prepared with varying amounts of the non-metallic crosslinker and are shown in Table 4. All gels were prepared at pH 12 with PHPA having a wt. average molecular weight of 5 M g/mol and 10% hydrolysis, and with PVP with Mw 55 k as the non-metallic crosslinker. As the data shows, in this embodiment, a minimum of 2% PHPA is needed in order to create a gel. A minimum of 2% PVP is needed at this PHPA concentration. With increased PHPA concentration to 3%, the minimum of PVP required is lowered to 1%.

TABLE 4

| | | | | | | |
|---|---|---|---|---|---|---|
| | 1% | PHPA | 2% | PHPA | 3% | PHPA |
| | 6 | MDa | 6 | MDa | 6 | MDa |
| PVP (wt %) ↓ | 10% | Hyd | 10% | Hyd | 10% | Hyd |

| | | | |
|---|---|---|---|
| 6 | Does not gel | Gel | Gel |
| 5 | Does not gel | Gel | Gel |
| 4 | Does not gel | Gel | Gel |
| 3 | Does not gel | Gel | Gel |
| 2 | Does not gel | Gel | Gel |
| 1 | — | Does not gel | Gel |
| 0.5 | — | | Does not gel |

### Effect of PVP Concentration on PHPA-PVP Gels

FIG. 4 shows the effect of the crosslinker concentration (PVP concentration) on the gel strength. All the gels were prepared using PVP with Mw 55 k. As the data shows, with 1% PVP, a gel already forms. Increasing PVP concentration gives a stronger gel. When PVP reaches 5%, further increasing PVP concentration does not further increase the gel strength.

### Effect of PVP Mw on PHPA-PVP Systems

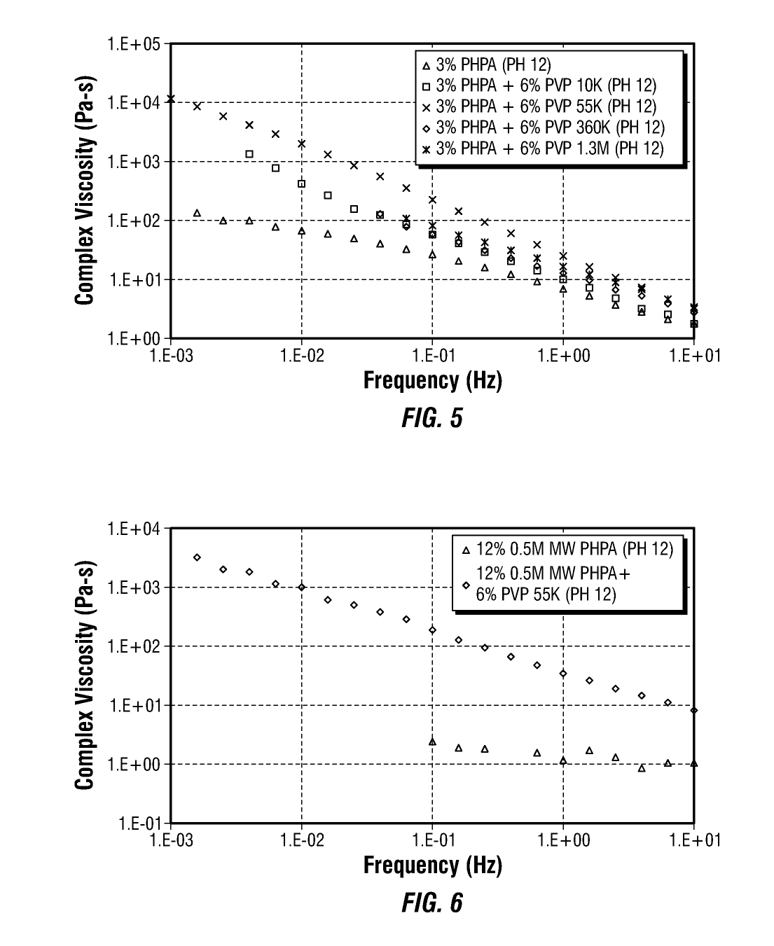

FIG. 5 shows the effects of PVP molecular weight on gel strength. All examples utilized 3% PHPA and 6% PVP with PVP Mw varied. As the data shows, the PVP Mw has a significant impact on the gel strength. Among all Mw tested, 55 k was the optimal. Higher or lower Mw crosslinkers all led to weaker systems, as indicated by the lower complex viscosities compared with the 55 k gel.

Low Mw PHPA Gels with PVP

As shown in FIG. 6, relatively low molecular weight PHPA are suitable for use herein. A low Mw PHPA of 0.5 million Mw with a 5% hydrolysis gelled with PVP. As the data shows, the concentration of the PHPA needed to produce the gel was higher than with higher molecular weight PHPA.

Non-Ionic Polyacrylamide Gels with PVP

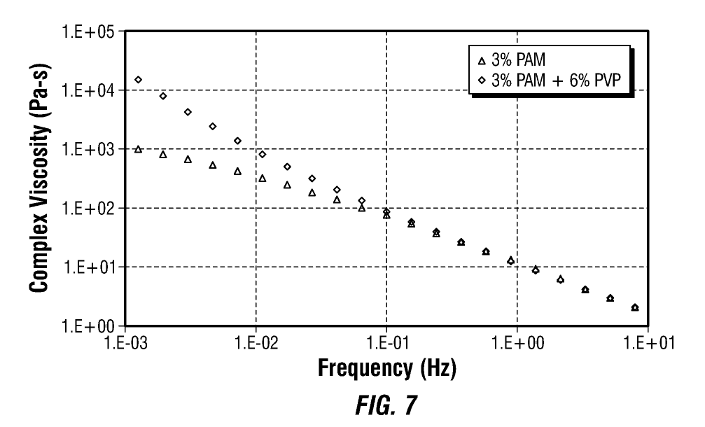

As shown in FIG. 7, non-ionic polyacrylamide (PAM) (i.e., with 0% hydroslysis) also produced gels with PVP. A 3% PAM, Mw of 6 million g/mol and 6% PVP 55 k.

PHPA Mixed with Another PHPA does not Gel

A comparative composition comprising the low molecular weight PHPA (0.5M g/mol, 5% hydrolysis) was combined with the 5M g/mol 10% hydrolysis PHPA to determine if any transamidation reaction would occur to form a gel among polyacrylamide molecules themselves. As expected, experiments showed no gel formed at pH 12. This data suggests that the pyrrolidone ring of the polylactam is more reactive and is needed in order for the reaction to take place to produce the gels of the instant disclosure.

### Order of Addition of Crosslinker and PHPA

It was determined that the order of addition of the PHPA and the non-metallic crosslinker is not of consequence in forming the gels of the instant disclosure. An experiment was performed to find out whether adjusting pH to 12 before PVP was added would give a gel with the PHPA, as opposed to raising the pH to 12 after PVP is added. It was concluded that the order did not matter. A strong gel still formed if pH was increased to 12 first before adding PVP and if the pH was increased to 12 after adding PVP.

### Dehydration of Gels and Reconstitution of Gels

A gel was produced according to the instant disclosure comprising 3 wt % PHPA and 6 wt % PVP at a pH of 12. The gel was freeze dried to produce a gel concentrate having less than 1 wt % water. The gel concentrate was then re-hydrated by mixing in water to produce a reconstituted gel having essentially the same properties as the gel prior to freeze drying.

The foregoing disclosure and description is illustrative and explanatory thereof and it can be readily appreciated by those skilled in the art that various changes in the size, shape and materials, as well as in the details of the illustrated construction or combinations of the elements described herein can be made without departing from the spirit of the disclosure.

While the invention has been illustrated and described in detail in the drawings and foregoing description, the same is to be considered as illustrative and not restrictive in character, it being understood that only some embodiments have been shown and described and that all changes and modifications that come within the spirit of the inventions are desired to be protected. It should be understood that while the use of words such as preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

I claim:

1. A gel comprising, greater than 1 wt % polyacrylamide crosslinked with a non-metallic crosslinker, the non-metallic crosslinker comprising a polylactam.

2. The gel of claim 1, wherein the polyacrylamide has a degree of hydrolysis less than or equal to about 40%.

3. The gel of claim 1, wherein the non-metallic crosslinker comprises greater than or equal to about 1 wt % polyvinylpyrrolidone, polyvinylcaprolactam, or a combination thereof independently having a weight average molecular weight of greater than or equal to about 10,000 g/mol and less than or equal to about 2 million g/mol

4. The gel of claim 1, having a pH of less than or equal to about 3 or greater than or equal to about 9.

5. The gel of claim 1, having a complex viscosity of greater than or equal to about 100 Pa·s at less than or equal to about 0.01 Hz.

6. The gel of claim 1, wherein G′−G″ is greater than or equal to about 0.1 Pa·s when determined using an oscillatory shear rheometer at a frequency of 1 Hz and at 20° C.

7. A method to produce a gel comprising:
contacting a composition comprising greater than or equal to about 3 wt % polyacrylamide with a non-metallic crosslinker comprising a polylactam at a pH of greater than or equal to about 9, or less than or equal to about 3, at a temperature and for a period of time sufficient to produce the gel,
wherein the polyacrylamide concentration in the gel is greater than about 1 wt % based on the total weight of the gel.

8. The method of claim 7, wherein the amount of the non-metallic crosslinker contacted with the polyacrylamide is sufficient to produce a gel having a concentration of the non-metallic crosslinker in the gel of greater than or equal to about 1 wt %, based on the total weight of the gel.

9. The method of claim 7, wherein the non-metallic crosslinker comprises polyvinylpyrrolidone, polyvinylcaprolactam, or a combination thereof independently having a weight average molecular weight of greater than or equal to about 10,000 g/mol and less than or equal to about 2 million g/mol.

10. The method of claim 7, wherein the temperature is greater than or equal to about 50° C.

11. A method to produce a gel concentrate comprising:
dehydrating the gel produced according to the method of claim 7 to produce the gel concentrate.

12. The method of claim 11, wherein the dehydrating the gel comprises freeze drying.

13. The method of claim 11, wherein the non-metallic crosslinker comprises polyvinylpyrrolidone, polyvinylcaprolactam, or a combination thereof independently having a weight average molecular weight of greater than or equal to about 10,000 g/mol and less than or equal to about 2 million g/mol, and
wherein the concentration of the non-metallic crosslinker in the gel is greater than or equal to about 1 wt %, based on the total weight of the gel.

14. A method to produce a reconstituted gel comprising:
contacting a composition comprising greater than or equal to about 3 wt % polyacrylamide with a non-metallic crosslinker comprising a polylactam at a first pH of greater than or equal to about 9, at a first temperature and for a first period of time sufficient to produce a first gel,
wherein the polyacrylamide concentration in the first gel is greater than about 1 wt %,
dehydrating the first gel to produce a gel concentrate; and
contacting the gel concentrate with an aqueous solution at a second pH, at a second temperature and for a second period of time sufficient to produce the reconstituted gel.

15. The method of claim 14, wherein the non-metallic crosslinker comprises polyvinylpyrrolidone, polyvinylcaprolactam, or a combination thereof independently having a weight average molecular weight of greater than or equal to about 10,000 g/mol and less than or equal to about 2 million g/mol, and
wherein the concentration of the non-metallic crosslinker in the first gel is greater than or equal to about 1 wt %, based on the total weight of the first gel.

16. A method of treating a wellbore comprising:
injecting a composition comprising the gel produced according to claim 11 into a wellbore.

17. A method of treating a wellbore comprising:
injecting a composition comprising greater than or equal to about 3 wt % polyacrylamide into a wellbore;
injecting a composition comprising a non-metallic crosslinker comprising a polylactam into the wellbore, and
injecting a pH adjusting fluid into the wellbore in an amount sufficient to produce a downhole solution pH of greater than or equal to about 9 or less than or equal to about 3, to produce an in-situ gel comprising greater than about 1 wt % polyacrylamide crosslinked with the non-metallic crosslinker,
wherein the composition comprising greater than or equal to about 3 wt % polyacrylamide, the composition comprising a non-metallic crosslinker, and the pH adjustment fluid are injected into the wellbore separately, simultaneously, or any combination thereof.

18. The method of claim 17, wherein the non-metallic crosslinker comprises polyvinylpyrrolidone, polyvinylcaprolactam, or a combination thereof independently having a weight average molecular weight of greater than or equal to about 10,000 g/mol and less than or equal to about 2 million g/mol, and
wherein the amount of non-metallic crosslinker injected is sufficient to produce the in-situ gel having a non-metallic crosslinker concentration of greater than or equal to about 1 wt %, based on the total weight of the in-situ gel.

19. A method of treating a wellbore comprising:
injecting a composition comprising a gel concentrate into a wellbore, the gel concentrate comprising polyacrylamide crosslinked with a non-metallic crosslinker comprising a polylactam to produce an in-situ reconstituted gel comprising greater than about 1 wt % polyacrylamide crosslinked with the non-metallic crosslinker.

20. The method of claim 19, wherein the non-metallic crosslinker comprises polyvinylpyrrolidone, polyvinylcaprolactam, or a combination thereof having a weight average molecular weight of greater than or equal to about 10,000 g/mol and less than or equal to about 2 million g/mol, and
wherein the concentration of the non-metallic crosslinker in the reconstituted gel is greater than or equal to about 1 wt %, based on the total weight of the reconstituted gel.

21. A well treatment fluid comprising the gel according to claim 1.
